(19) United States
(12) Patent Application Publication
(10) Pub. No.: US 2015/0240860 A1
(43) Pub. Date: Aug. 27, 2015

(54) SPACE-SAVING RESILIENT ASSEMBLY ELEMENT AND PACKING STRUCTURE THEREOF

(71) Applicant: DTECH PRECISION INDUSTRIES CO., LTD., New Taipei (TW)

(72) Inventor: TING-JUI WANG, New Taipei (TW)

(73) Assignee: DTECH PRECISION INDUSTRIES CO., LTD., New Taipei (TW)

(21) Appl. No.: 14/623,831

(22) Filed: Feb. 17, 2015

(30) Foreign Application Priority Data
Feb. 21, 2014 (TW) 103203008

(51) Int. Cl. F16B 39/26

(52) U.S. Cl. CPC F16B 39/26

(57) ABSTRACT

A space-saving resilient assembly element is adapted to fix a first object and a second object in place. The resilient assembly element includes an assembly element body and a conical resilient element. The assembly element body has a head, a rod connected to the head, and an assembly portion connected to the rod. The assembly portion connects with the first object. The conical resilient element is disposed around the rod. The conical resilient element has a first end and a second end. The first end abuts against the head, and the second end abuts against the second object. The conical resilient element is compressed and deformed to become tablet-shaped, curved, conical, or layer by layer. Therefore, the space occupied by the resilient assembly element is reduced.

### CROSS-REFERENCE TO RELATED APPLICATION

This non-provisional application claims priority under 35 U.S.C. §119(a) on Patent Application No(s). 103203008 filed in Taiwan, R.O.C. on Feb. 21, 2014, the entire contents of which are hereby incorporated by reference.

### FIELD OF THE INVENTION

The present invention relates to assembly elements, and more particularly, to a space-saving resilient assembly element whereby a conical resilient element of the resilient assembly element is compressed to become tablet-shaped and therefore reduce the space occupied by the resilient assembly element.

### BACKGROUND OF THE INVENTION

A conventional resilient assembly element for fixing two objects (i.e., a first object and a second object) in place comprises a screw and a spring. A user must apply a force to the screw with a tool in order to fix the first object in place with the screw. As soon as the screw is screwed to the first object, the spring is compressed to thereby work together with the first object in clamping the second object, thereby fixing the two objects in place.

After the spring has been compressed, rings of the spring get closer to each other vertically to thereby form a compression length. To screw the screw to the first object, the screw must have a length larger than the compression length of the spring. As a result, the resilient assembly element takes up much space when in use.

Therefore, the present invention is intended to disclose a resilient assembly element whereby the compression length of the spring is reduced to thereby reduce the space occupied by the resilient assembly element.

### SUMMARY OF THE INVENTION

To solve the aforesaid problem, an objective of the present invention is to provide a space-saving resilient assembly element whereby the compression length of a resilient element is reduced to thereby reduce the space occupied by the resilient assembly element.

In order to achieve the above and other objectives, the present invention provides a space-saving resilient assembly element for fixing a first object and a second object in place. The resilient assembly element comprises an assembly element body and a conical resilient element.

The assembly element body has: a head; a rod connected to the head; and an assembly portion connected to the rod to thereby connect with the first object.

The conical resilient element is disposed around the rod. The conical resilient element has a first end and a second end. The first end abuts against the head, and the second end abuts against the second object.

The conical resilient element is compressed and deformed to become tablet-shaped, curved, conical, or layer by layer.

Regarding the resilient assembly element, the assembly element body further has a concave engaging portion disposed at the rod, and the first end of the conical resilient element connects with the concave engaging portion.

Regarding the resilient assembly element, the assembly element body further has a guiding portion disposed on a sidewall of the rod to thereby guide the first end of the conical resilient element to the concave engaging portion.

Regarding the resilient assembly element, the second end of the conical resilient element is fixed to the second object by expanding, riveting, welding, engagement, adhesion, fastening, snap-engagement, or magnetic attraction.

Regarding the resilient assembly element, the guiding portion is a guiding oblique surface or a guiding arc surface.

The resilient assembly element further comprises: a sleeve movably disposed around the assembly portion of the assembly element body, wherein the sleeve has a first limiting portion disposed at an upper portion of the sleeve, and the first limiting portion limits the second end of the conical resilient element; and a fixing portion disposed at a bottom of the sleeve, with the fixing portion fixed to the second object.

Regarding the resilient assembly element, the first limiting portion is a lateral concave snap-engagement structure to limit the second end of the conical resilient element.

The resilient assembly element further comprises: a sleeve movably disposed around the rod of the assembly element body, wherein the sleeve has a first limiting portion disposed at an upper portion of the sleeve; and a fixing portion disposed at a bottom of the sleeve, with the fixing portion fixed to the second object; wherein the rod of the assembly element body further has a second limiting portion, such that the first limiting portion and the second limiting portion are engaged with each other.

Regarding the resilient assembly element, the first end of the conical resilient element abuts against the first limiting portion of the sleeve, and the second end of the conical resilient element abuts against the second limiting portion of the rod.

Regarding the resilient assembly element, the first end of the conical resilient element abuts against the head, and the second end of the conical resilient element abuts against the upper portion of the sleeve.

Regarding the resilient assembly element, the fixing portion of the sleeve is fixed to the second object by expanding, riveting, welding, engagement, adhesion, fastening, snap-engagement, or magnetic attraction.

Regarding the resilient assembly element, the assembly element body further has an abutting portion disposed on a bottom side of the rod.

Regarding the resilient assembly element, the conical resilient element is a conical compressible spring, a curved leaf spring, or a C-shaped engaging element.

Regarding the resilient assembly element, the assembly portion of the assembly element body is a thread structure, a cylinder structure, a convex engaging body structure, a concave engaging body structure, or a resilient engaging body structure.

Regarding the resilient assembly element, the diameter of the first end of the conical resilient element is less than the diameter of the second end of the conical resilient element.

Regarding the resilient assembly element, the diameter of the first end of the conical resilient element is larger than the diameter of the second end of the conical resilient element.

In addition, the present invention further provides a packing structure for use in packing at least one said resilient assembly element. The packing structure comprises at least a limiting receiving body which has a limiting receiving space, such that the resilient assembly elements are received in the limiting receiving space.

The packing structure further comprises a cover disposed at a top of the limiting receiving body and adapted to conceal the limiting receiving space.

In conclusion, a space-saving resilient assembly element of the present invention has a conical resilient element which is compressed and deformed to become tablet-shaped and therefore reduce the space occupied by the resilient assembly element. In addition, the packing structure of the present invention has a limiting receiving body for preventing the resilient assembly element from shaking or tilting.

### BRIEF DESCRIPTION OF THE DRAWINGS

Objectives, features, and advantages of the present invention are hereunder illustrated with specific embodiments in conjunction with the accompanying drawings, in which:

FIG. 1 and FIG. 2 are schematic views of a resilient assembly element in coupling two objects together according to the first specific embodiment of the present invention;

FIG. 3 and FIG. 4 are schematic views of the resilient assembly element in coupling two objects together according to the second specific embodiment of the present invention;

FIG. 5 is a schematic view of the conical resilient element being a curved leaf spring or a C-shaped engaging element;

FIG. 6 and FIG. 7 are schematic views of the resilient assembly element in coupling two objects together according to the third specific embodiment of the present invention;

FIG. 8 and FIG. 9 are schematic views of the resilient assembly element in coupling two objects together according to the fourth specific embodiment of the present invention;

FIG. 10 is a schematic view of the resilient assembly element according to the fifth specific embodiment of the present invention;

FIG. 11 is a schematic view of the resilient assembly element according to the sixth specific embodiment of the present invention;

FIG. 12 is a schematic view of the resilient assembly element according to the seventh specific embodiment of the present invention; and

FIG. 13 is a schematic view of a packing structure according to a specific embodiment of the present invention.

### DETAILED DESCRIPTION OF THE PREFERRED EMBODIMENTS

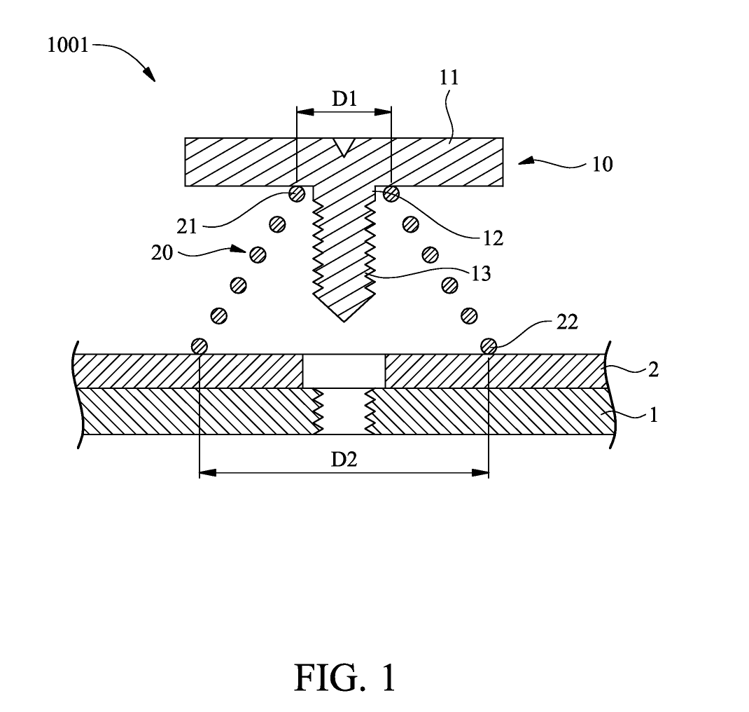

Referring to FIG. 1, it is a schematic view of a resilient assembly element 1001 according to the first specific embodiment of the present invention. The resilient assembly element 1001 is adapted to fix a first object 1 and a second object 2 in place. The resilient assembly element 1001 comprises an assembly element body 10 and a conical resilient element 20.

The assembly element body 10 has a head 11, a rod 12, and an assembly portion 13. The rod 12 is connected to the head 11. The assembly portion 13 is connected to the rod 12 to thereby connect with the first object 1. As shown in FIG. 1, the assembly portion 13 is a thread structure.

The conical resilient element 20 is disposed around the rod 12. The conical resilient element 20 has a first end 21 and a second end 22. The first end 21 abuts against the head 11, and the second end 22 abuts against the second object 2. The conical resilient element 20 is a conical compressible spring. The diameter D1 of the first end 21 of the conical resilient element 20 is less than the diameter D2 of the second end 22 of the conical resilient element 20. In addition, the second end 22 of the conical resilient element 20 is fixed to the second object 2 preferably by expanding, riveting, welding, engagement, adhesion, fastening, snap-engagement, or magnetic attraction.

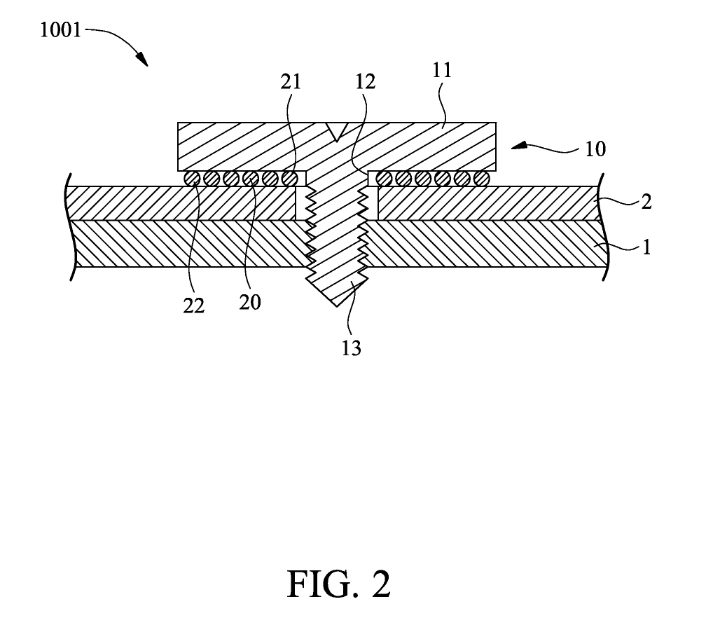

Referring to FIG. 2, when the assembly portion 13 of the resilient assembly element 1001 connects with the first object 1, the conical resilient element 20 is compressed and deformed to become tablet-shaped. Since the compression length of the conical resilient element 20 equals just a spring linear diameter and therefore is tiny, it is not necessary for the rod 12 and the assembly portion 13 of the resilient assembly element 1001 to be long in order to fix the first object 1 and the second object 2 in place, thereby reducing the space occupied by the resilient assembly element 1001.

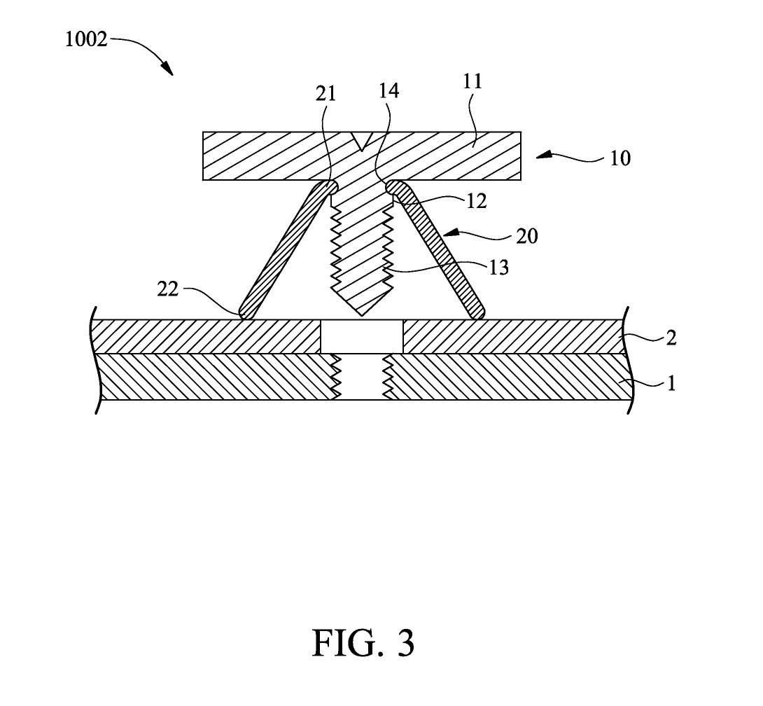

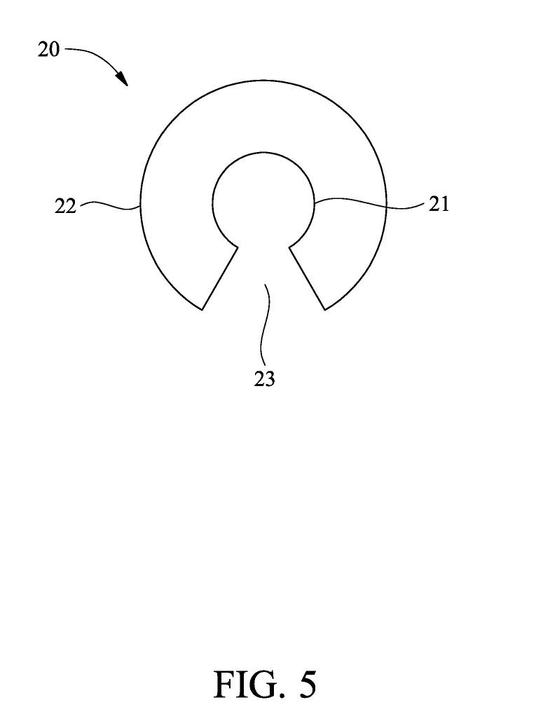

Referring to FIG. 3, it is a schematic view of a resilient assembly element 1002 according to the second specific embodiment of the present invention. The components of the resilient assembly element 1002 are substantially identical to the components of the resilient assembly element 1001, respectively. The assembly element body 10 further has a concave engaging portion 14 disposed at the rod 12 and preferably disposed at the junction of the head 11 and the rod 12, such that the first end 21 of the conical resilient element 20 connects with the concave engaging portion 14. Therefore, the conical resilient element 20 gets connected to the assembly element body 10 firmly. In addition, referring to FIG. 5, which is a schematic top view of the conical resilient element 20 in FIG. 3, the conical resilient element 20 is a curved leaf spring or a C-shaped engaging element. The curved leaf spring or the C-shaped engaging element has an opening 23. The assembly element body 10 can be easily disposed into the conical resilient element 20 from the opening 23.

In addition, a groove (not shown) is disposed on the surface of the second object 2 to receive the second end 22 of the conical resilient element 20. When the conical resilient element 20 is compressed, the second end 22 moves along the groove, such that the conical resilient element 20 is compressed and deformed to become conical.

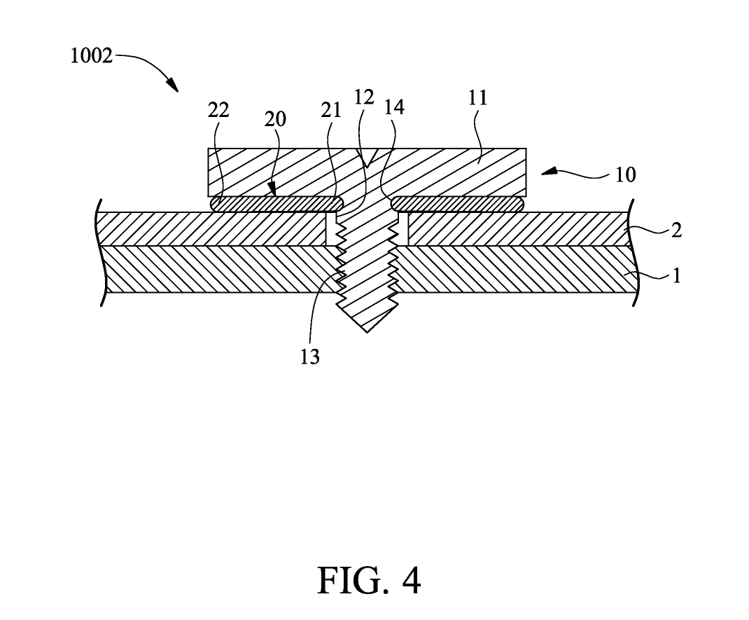

Referring to FIG. 4, when the assembly portion 13 of the resilient assembly element 1002 connects with the first object 1, the conical resilient element 20 is compressed and deformed to become tablet-shaped. Therefore, the curved leaf spring is compressed and deformed to become tablet-shaped.

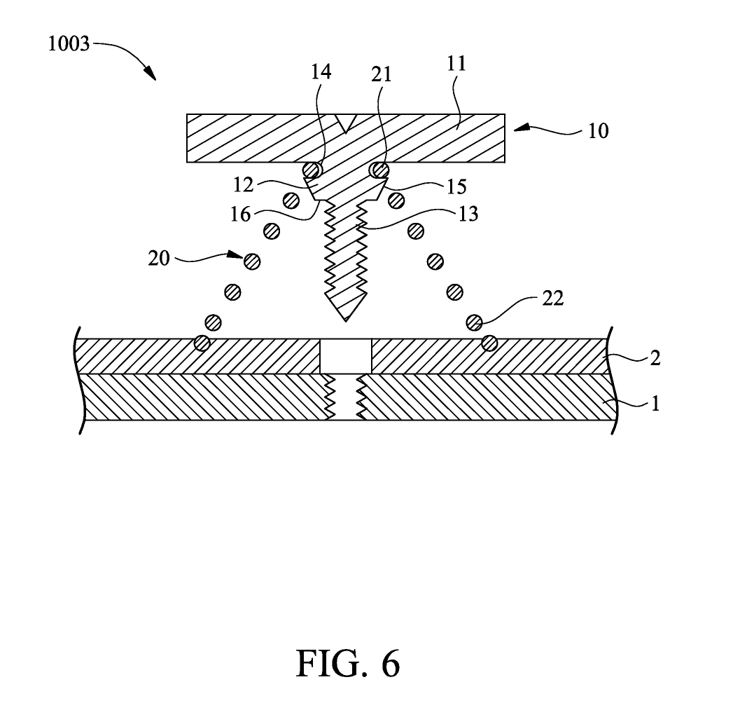

Referring to FIG. 6, it is a schematic view of a resilient assembly element 1003 according to the third specific embodiment of the present invention. The components of the resilient assembly element 1003 are substantially identical to the components of the resilient assembly element 1001, respectively. The assembly element body 10 further has a concave engaging portion 14, a guiding portion 15, and an abutting portion 16. The concave engaging portion 14 is disposed at the junction of the head 11 and the rod 12, such that the first end 21 of the conical resilient element 20 connects with the concave engaging portion 14. The guiding portion 15 is disposed on the sidewall of the rod 12 such that the first end 21 of the conical resilient element 20 is guided to the concave engaging portion 14. The guiding portion 15 is preferably a guiding oblique surface or a guiding arc surface. The abutting portion 16 is disposed on a bottom side of the rod 12. In addition, to allow the resilient assembly element 1003 to fix the first object 1 and the second object 2 in place, the second end 22 of the conical resilient element 20 has to be embedded in the second object 2.

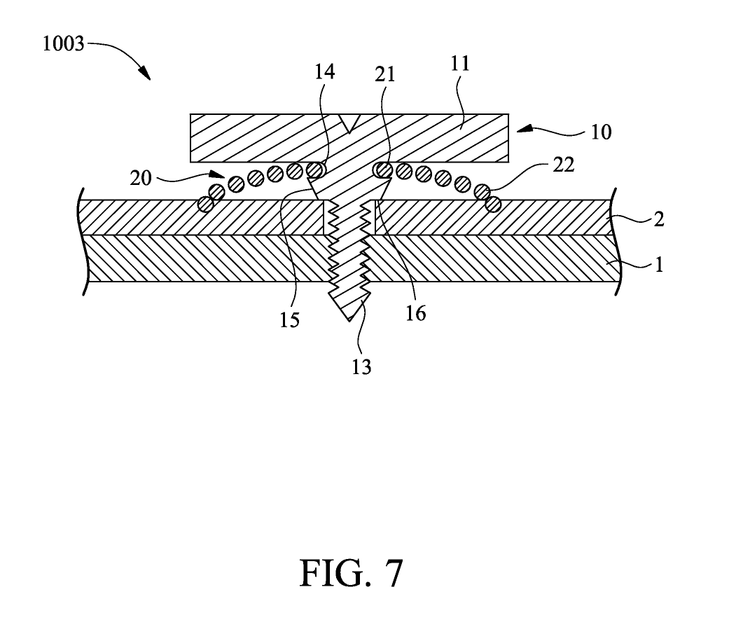

Referring to FIG. 7, to allow the assembly portion 13 of the resilient assembly element 1003 to connect with the first object 1, the abutting portion 16 abuts against the second object 2, such that the resilient assembly element 1003 fixes the first object 1 and the second object 2 in place firmly. The conical resilient element 20 is curved.

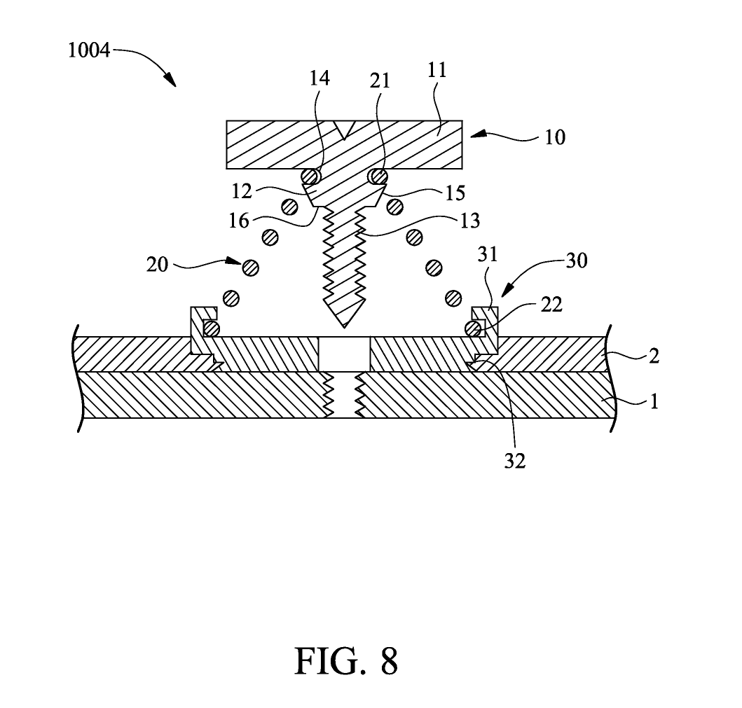

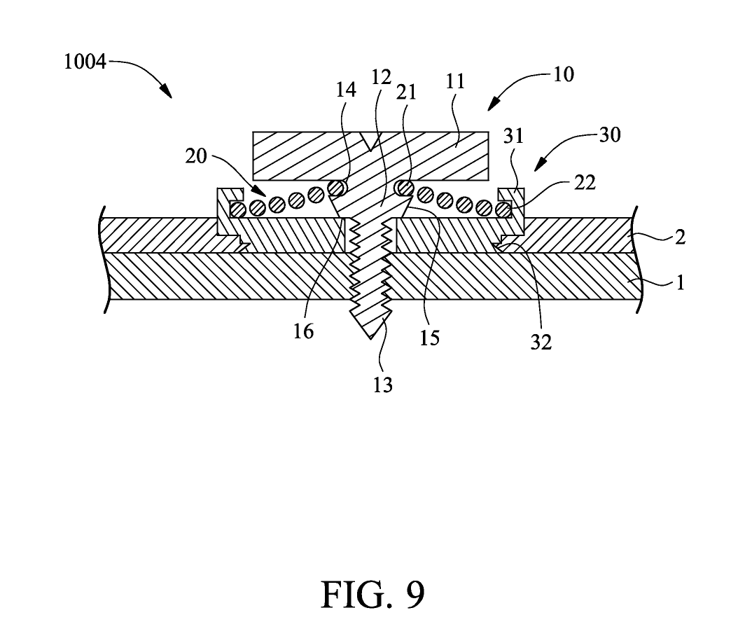

Referring to FIG. 8 and FIG. 9, they are schematic views of a resilient assembly element 1004 according to the fourth specific embodiment of the present invention. The components of the resilient assembly element 1004 are substantially identical to the components of the resilient assembly element 1003, respectively. The resilient assembly element 1004 further comprises a sleeve 30 movably disposed around the assembly portion 13 of the assembly element body 10. The sleeve 30 has a first limiting portion 31 and a fixing portion 32. The first limiting portion 31 is disposed at an upper portion of the sleeve 30. The first limiting portion 31 limits the second end 22 of the conical resilient element 20. The upper portion is defined as any portion of the sleeve 30 except a bottom thereof. The second end 22 of the conical resilient element 20 is limited in the first limiting portion 31 by expanding, riveting, welding, engagement, adhesion, fastening, snap-engagement, or magnetic attraction. As shown in FIG. 8, the first limiting portion 31 is a lateral concave snap-engagement structure to limit the second end 22 of the conical resilient element 20. The fixing portion 32 is disposed at the bottom of the sleeve 30. The fixing portion 32 is fixed to the second object 2. The fixing portion 32 is fixed in place by expanding, riveting, welding, engagement, adhesion, fastening, snap-engagement, or magnetic attraction. The conical resilient element 20 looks conical and can be the curved leaf spring or the C-shaped engaging element as shown in FIG. 5.

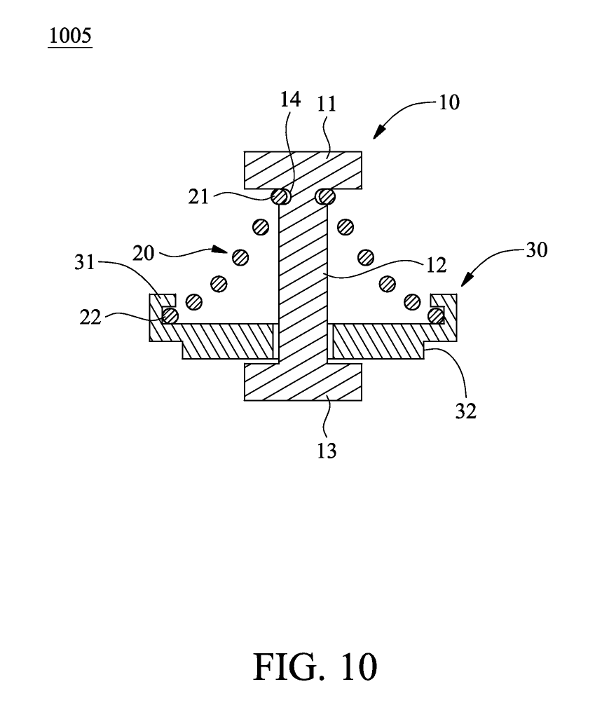

Referring to FIG. 10, it is a schematic view of a resilient assembly element 1005 according to the fifth specific embodiment of the present invention. The components of the resilient assembly element 1005 are substantially identical to the components of the resilient assembly element 1004, respectively. The assembly element body 10 of the resilient assembly element 1005 lacks the guiding portion 15 and the abutting portion 16. The engaging portion 13 is a convex engaging body structure or a resilient engaging body structure. The conical resilient element 20 looks conical and can be the curved leaf spring or the C-shaped engaging element as shown in FIG. 5.

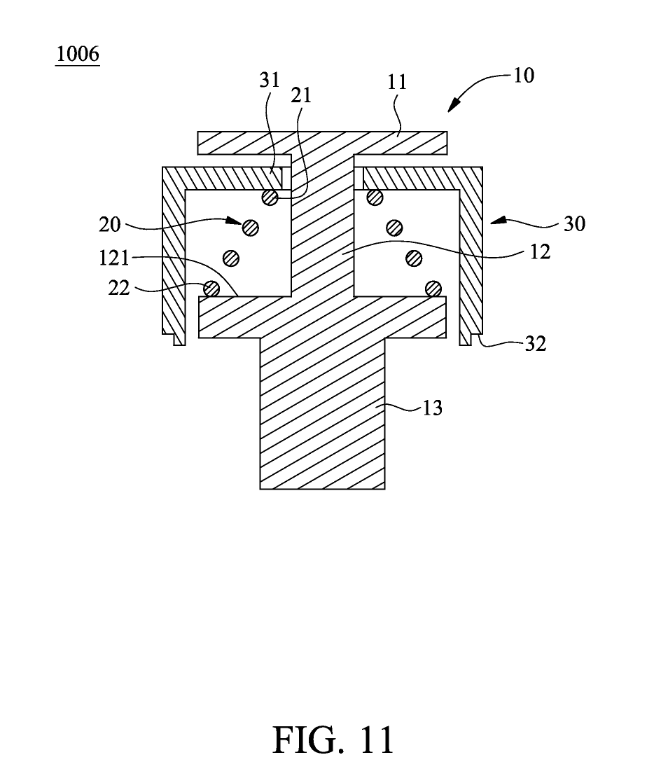

Referring to FIG. 11, it is a schematic view of a resilient assembly element 1006 according to the sixth specific embodiment of the present invention. The assembly element body 10 of the resilient assembly element 1006 is substantially identical to the assembly element body 10 of the resilient assembly element 1005. The engaging portion 13 of the resilient assembly element 1006 is a cylinder structure. In addition, the resilient assembly element 1006 comprises a sleeve 30 and the rod 12 movably disposed around the assembly element body 10. The sleeve 30 has a first limiting portion 31 and a fixing portion 32. The first limiting portion 31 is disposed at an upper portion of the sleeve 30. The upper portion is defined as any portion of the sleeve 30 except a bottom thereof. The fixing portion 32 is disposed at the bottom of the sleeve 30. The fixing portion 32 is fixed to the second object 2 by expanding, riveting, welding, engagement, adhesion, fastening, snap-engagement, or magnetic attraction. The rod 12 of the assembly element body 10 further has a second limiting portion 121, such that the first limiting portion 31 and the second limiting portion 121 are engaged with each other.

In addition, the first end 21 of the conical resilient element 20 abuts against the first limiting portion 31 of the sleeve 30, and the second end 22 of the conical resilient element 20 abuts against the second limiting portion 121 of the rod 12.

Although it is not shown, it is understandable that the conical resilient element 20 has not yet been compressed when the resilient assembly element 1006 fixes the first object 1 and the second object 2 in place, and that the assembly element body 10 of the resilient assembly element 1006 is lifted to separate the assembly portion 13 from the first object 1 such that the conical resilient element 20 is compressed and deformed to become tablet-shaped. Since the compression length of the conical resilient element 20 equals just a spring linear diameter and therefore is tiny, it is not necessary for the rod 12 of the resilient assembly element 1001 to be long, thereby reducing the overall dimensions of the resilient assembly element 1001.

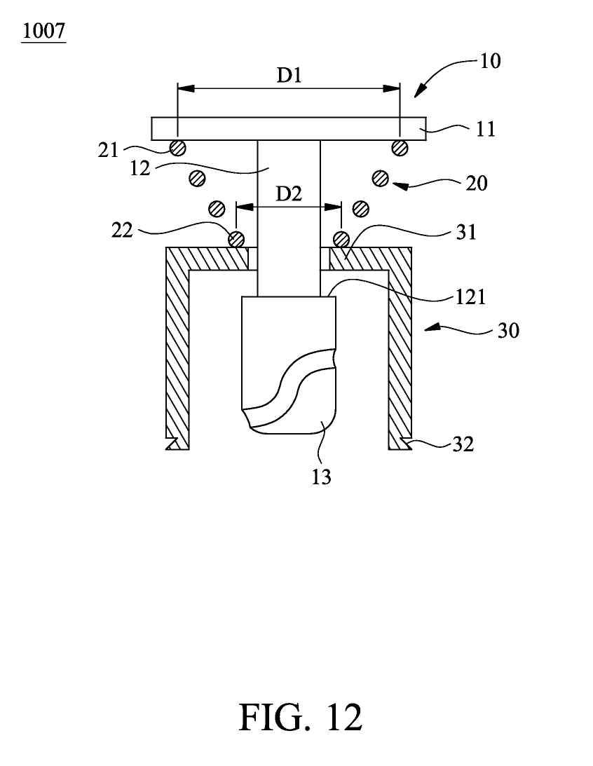

Referring to FIG. 12, it is a schematic view of a resilient assembly element 1007 according to the seventh specific embodiment of the present invention. The components of the resilient assembly element 1007 are substantially identical to the components of the resilient assembly element 1006, respectively. The engaging portion 13 of the resilient assembly element 1007 is a concave engaging body structure. In addition, the first end 21 of the conical resilient element 20 abuts against the head 11, and the second end 22 of the conical resilient element 20 abuts against the upper portion of the sleeve 30. The diameter D1 of the first end 21 of the conical resilient element 20 is larger than the diameter D2 of the second end 22 of the conical resilient element 20.

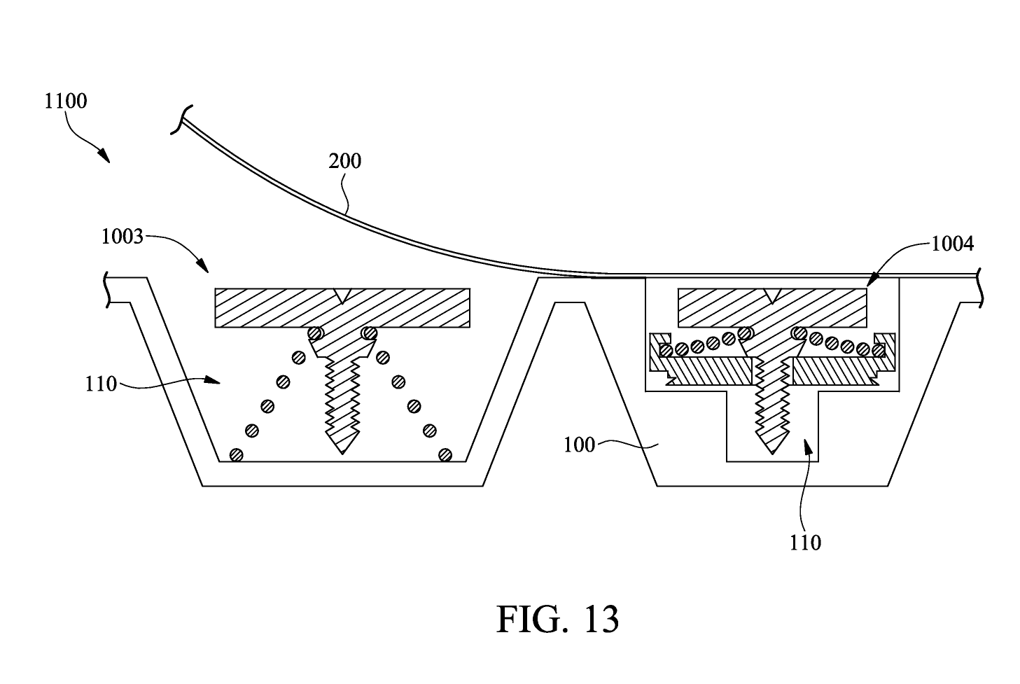

Referring to FIG. 13, it is a schematic view of a packing structure 1100 according to a specific embodiment of the present invention. The packing structure 1100 is for packing any one of the resilient assembly elements 1001-1007. As shown in FIG. 13, the packing structure 1100 comprises at least a limiting receiving body 100 which has a limiting receiving space 110, such that the resilient assembly elements 1003, 1004 are received in the limiting receiving space 110. Therefore, the packing structure 1100 prevents the resilient assembly elements 1003, 1004 from shaking or tilting.

Referring to FIG. 13, the packing structure 1100 further comprises a cover 200. When the resilient assembly elements 1003, 1004 are received in the limiting receiving space 110, the cover 200 is disposed at a top of the limiting receiving body 100 to conceal the limiting receiving space 110. Therefore, a user moves the packing structure 1100 to not only effectively prevent the resilient assembly elements 1003, 1004 from shaking but also prevent the resilient assembly elements 1003, 1004 from escaping from the limiting receiving space 110.

In conclusion, the present invention provides a space-saving resilient assembly element which has a conical resilient element operable to be compressed and deformed to thereby become tablet-shaped, thereby reducing the space occupied by the resilient assembly element. In addition, the present invention provides a packing structure which has a limiting receiving body for preventing the resilient assembly element from shaking or tilting. The packing structure of the present invention further has a cover for preventing the resilient assembly element from escaping from the limiting receiving space.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A space-saving resilient assembly element, adapted to fix a first object and a second object in place, the resilient assembly element comprising:
an assembly element body, having:
a head;
a rod connected to the head; and
an assembly portion connected to the rod to thereby connect with
the first object; and
a conical resilient element disposed around the rod and having a first end and a second end, wherein the first end abuts against the head, and the second end abuts against the second object;
wherein the conical resilient element is compressed and deformed to become tablet-shaped, curved, conical, or layer by layer.

2. The resilient assembly element of claim 1, wherein the assembly element body further has a concave engaging portion disposed at the rod, and the first end of the conical resilient element connects with the concave engaging portion.

3. The resilient assembly element of claim 2, wherein the assembly element body further has a guiding portion disposed on a sidewall of the rod to guide the first end of the conical resilient element to the concave engaging portion.

4. The resilient assembly element of claim 1, wherein the second end of the conical resilient element is fixed to the second object by expanding, riveting, welding, engagement, adhesion, fastening, snap-engagement, or magnetic attraction.

5. The resilient assembly element of claim 3, wherein the guiding portion is a guiding oblique surface or a guiding arc surface.

6. The resilient assembly element of claim 1, further comprising a sleeve movably disposed around the assembly portion of the assembly element body, the sleeve having:
a first limiting portion disposed at an upper portion of the sleeve and adapted to limit the second end of the conical resilient element; and
a fixing portion disposed at a bottom of the sleeve and fixed to the second object.

7. The resilient assembly element of claim 6, the first limiting portion is a lateral concave snap-engagement structure to limit the second end of the conical resilient element.

8. The resilient assembly element of claim 1, further comprising a sleeve movably disposed around the rod of the assembly element body, the sleeve having:
a first limiting portion disposed at an upper portion of the sleeve; and
a fixing portion disposed at a bottom of the sleeve and fixed to the second object; wherein the rod of the assembly element body further has a second limiting portion, such that the first limiting portion and the second limiting portion are engaged with each other.

9. The resilient assembly element of claim 8, wherein the first end of the conical resilient element abuts against the first limiting portion of the sleeve, and the second end of the conical resilient element abuts against the second limiting portion of the rod.

10. The resilient assembly element of claim 8, wherein the first end of the conical resilient element abuts against the head, and the second end of the conical resilient element abuts against the upper portion of the sleeve.

11. The resilient assembly element of claim 5, wherein the fixing portion of the sleeve is fixed to the second object by expanding, riveting, welding, engagement, adhesion, fastening, snap-engagement, or magnetic attraction.

12. The resilient assembly element of claim 6, wherein the fixing portion of the sleeve is fixed to the second object by expanding, riveting, welding, engagement, adhesion, fastening, snap-engagement, or magnetic attraction.

13. The resilient assembly element of claim 7, wherein the fixing portion of the sleeve is fixed to the second object by expanding, riveting, welding, engagement, adhesion, fastening, snap-engagement, or magnetic attraction.

14. The resilient assembly element of claim 8, wherein the fixing portion of the sleeve is fixed to the second object by expanding, riveting, welding, engagement, adhesion, fastening, snap-engagement, or magnetic attraction.

15. The resilient assembly element of claim 9, wherein the fixing portion of the sleeve is fixed to the second object by expanding, riveting, welding, engagement, adhesion, fastening, snap-engagement, or magnetic attraction.

16. The resilient assembly element of claim 10, wherein the fixing portion of the sleeve is fixed to the second object by expanding, riveting, welding, engagement, adhesion, fastening, snap-engagement, or magnetic attraction.

17. The resilient assembly element of claim 1, wherein the assembly element body further has an abutting portion disposed on a bottom side of the rod.

18. The resilient assembly element of claim 1, wherein the conical resilient element is one of a conical compressible spring, a curved leaf spring, and a C-shaped engaging element.

19. The resilient assembly element of claim 1, wherein the assembly portion of the assembly element body is one of a thread structure, a cylinder structure, a convex engaging body structure, a concave engaging body structure, and a resilient engaging body structure.

20. The resilient assembly element of claim 1, wherein a diameter of the first end of the conical resilient element is less than a diameter of the second end of the conical resilient element.

21. The resilient assembly element of claim 1, wherein a diameter of the first end of the conical resilient element is larger than a diameter of the second end of the conical resilient element.

22. A packing structure, for packing at least a resilient assembly element of claim 1, the packing structure comprising at least a limiting receiving body having a limiting receiving space, wherein the resilient assembly elements are received in the limiting receiving space.

23. The packing structure of claim 22, further comprising a cover disposed at a top of the limiting receiving body to conceal the limiting receiving space.
